(19) United States
(12) Patent Application Publication
(10) Pub. No.: US 2019/0283232 A1
(43) Pub. Date: Sep. 19, 2019

(54) STORAGE STRUCTURE FOR FLUID PUMPING DEVICE

(71) Applicant: LIH YANN INDUSTRIAL CO., LTD., Taichung City (TW)

(72) Inventor: Po-Lin Liao, Taichung City (TW)

(21) Appl. No.: 16/128,810

(22) Filed: Sep. 12, 2018

(30) Foreign Application Priority Data
Mar. 19, 2018 (TW) 107109274

(51) Int. Cl. B25F 5/02

(52) U.S. Cl. CPC B25F 5/029; F01M 11/0458

(57) ABSTRACT

A storage structure for fluid pumping device adapted for disposing on a fluid pumping device comprises: a ring body, sleeved onto the fluid pumping device; a plurality of storage portions, arranged around the ring body, each of the storage portions being adapted for a workpiece to removably connected.

### BACKGROUND OF THE INVENTION

### Field of the Invention

The present invention relates to a storage structure for fluid pumping device.

### Description of the Prior Art

Generally, when changing oil such as transmission fluid, the oil in the transmission box has to be drained, and new oil is injected into the transmission box by injector. The injector usually has a pumping mechanism to drain the oil in the transmission box and to inject the new oil into the transmission box.

Transmission boxes are various in types. Different types of transmission box need different connector to be connected to the injector. In a general motor repair shop, different kinds of connector are prepared, and different tools for detaching the connectors are also prepared. It is inconvenient that the user usually hangs the connectors and the tools on the waist or leaves them on the floor. Therefore, the efficiency of changing oil is low.

### SUMMARY OF THE INVENTION

The main object of the present invention is to provide a fluid pumping device which is capable of workpiece storage.

To achieve the above and other objects, a storage structure for fluid pumping device of the present invention is adapted for disposing on a fluid pumping device and comprises: a ring body, sleeved onto the fluid pumping device; a plurality of storage portions, arranged around the ring body, each of the storage portions being adapted for a workpiece to removably connected.

To achieve the above and other objects, a storage structure for fluid pumping device of the present invention comprises: a barrel; a plurality of storage portions, arranged around the barrel to disposed on a periphery of the barrel, each of the storage portions being adapted for a workpiece to removably connected.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a first embodiment of the present invention;

FIG. 2 is a breakdown drawing showing a first embodiment of the present invention;

FIG. 3 is a partial profile showing a first embodiment of the present invention;

FIG. 4 is a partial breakdown drawing showing a first embodiment of the present invention;

FIG. 5 is a top view showing a first embodiment of the present invention;

FIG. 6 is a stereogram showing a second embodiment of the present invention;

FIG. 7 is a stereogram showing a third embodiment of the present invention.

### DETAILED DESCRIPTION OF THE PREFERRED EMBODIMENTS

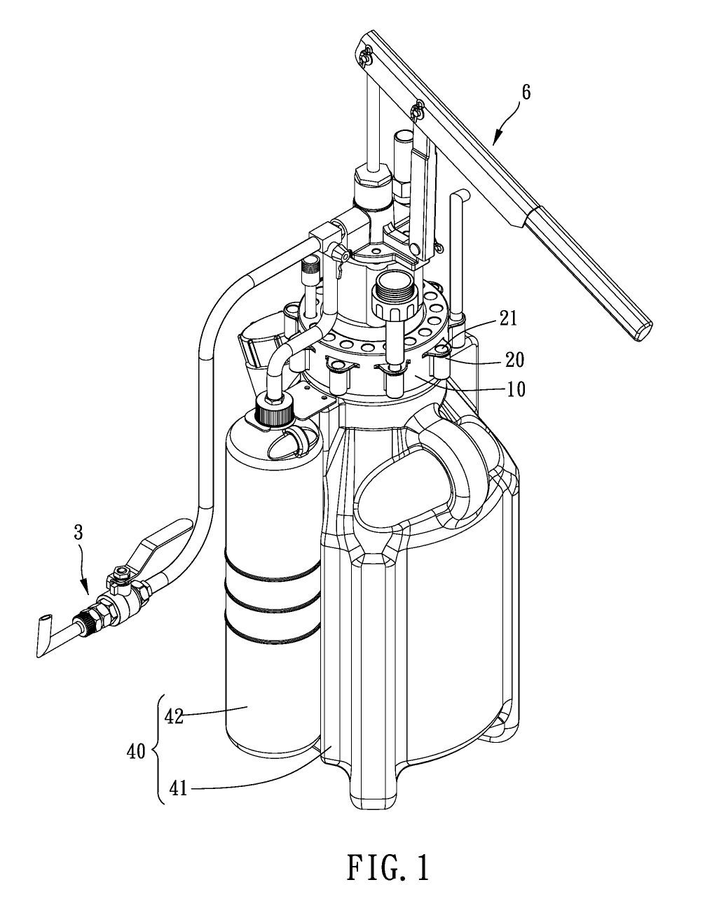

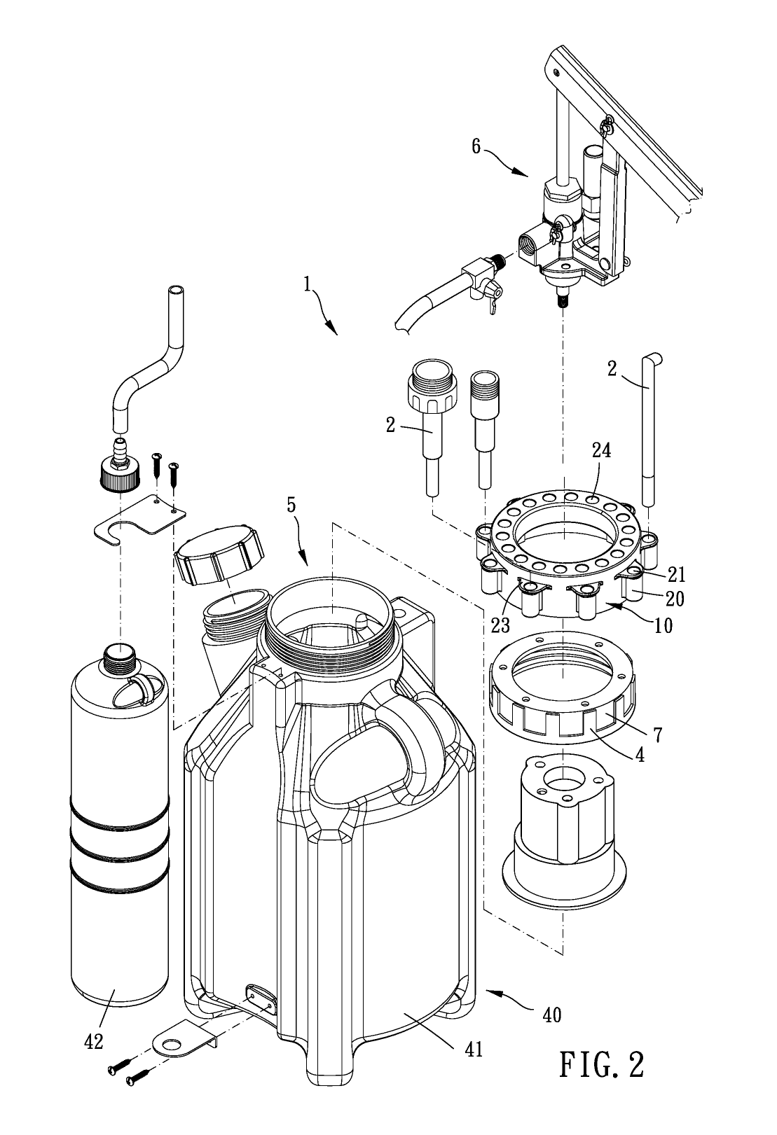

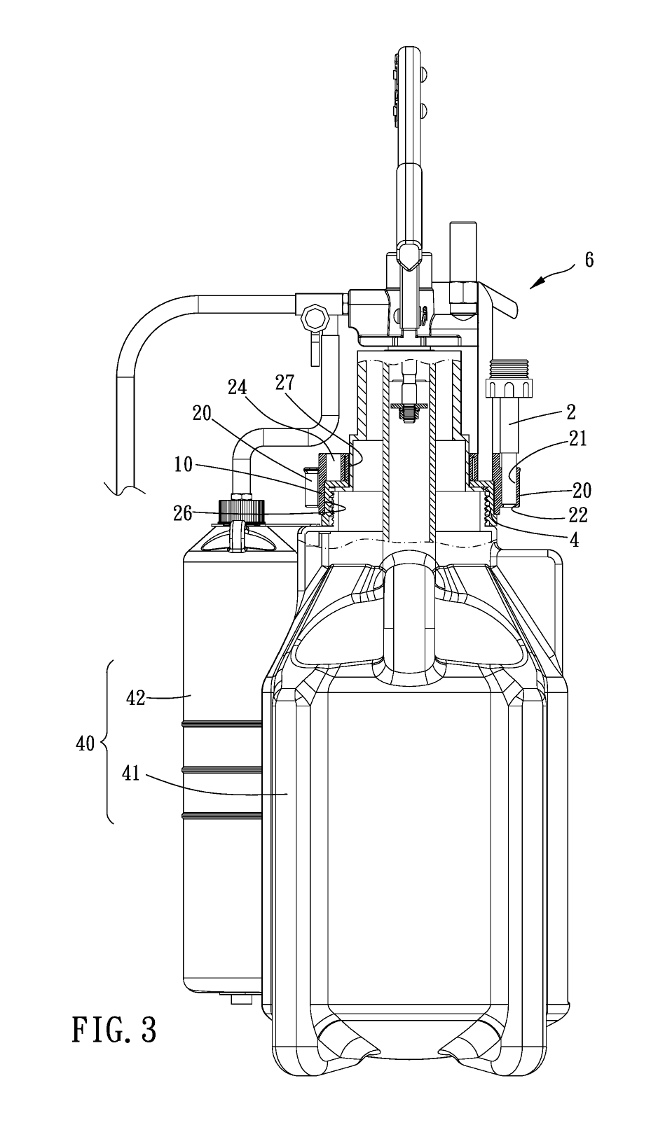

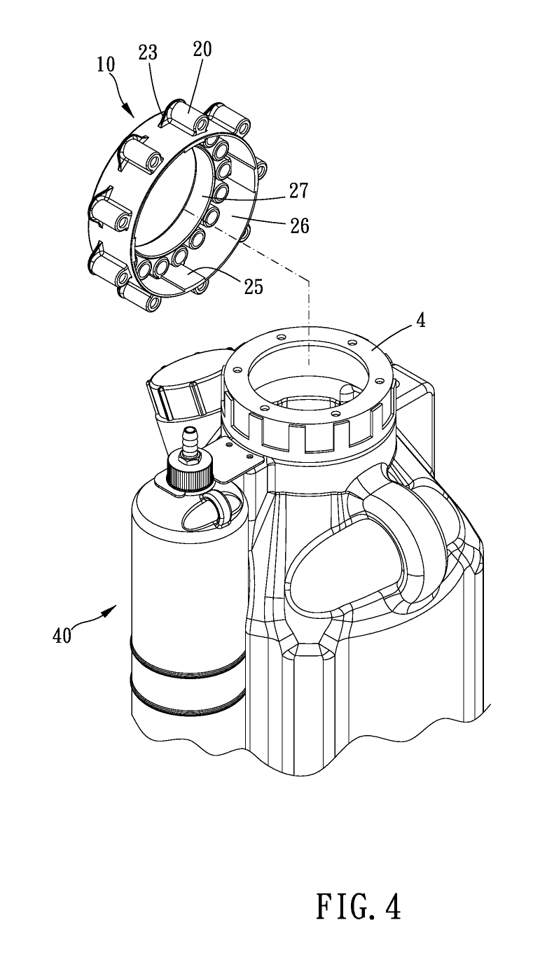

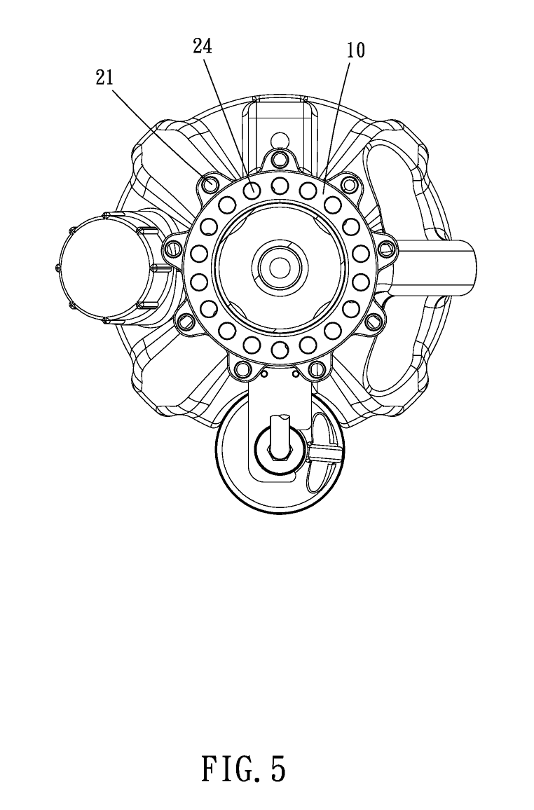

Please refer to FIG. 1 to FIG. 5 for the first embodiment of the present invention. The storage structure for fluid pumping device is adapted for being disposed on a fluid pumping device 1. The storage structure for fluid pumping device comprises a ring body 10 and a plurality of 20.

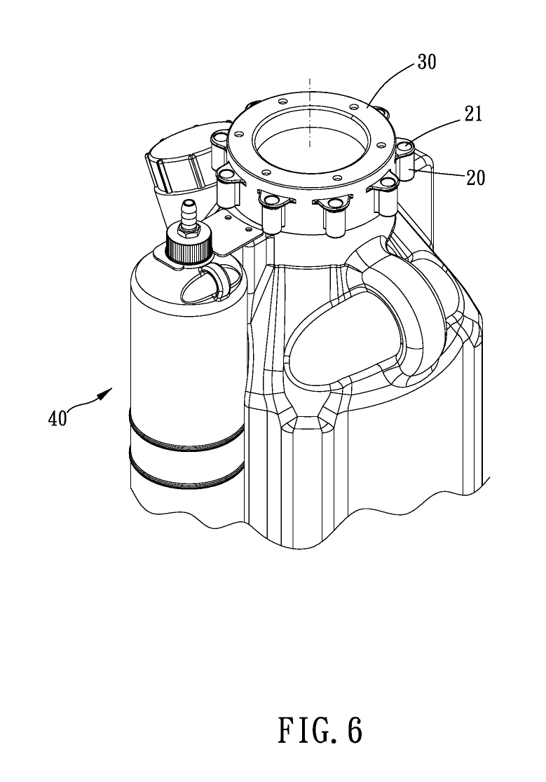

The ring body 10 is adapted for being sleeved onto the fluid pumping device 1, such as a liquid injector. The storage portions 20 is disposed on the ring body 10 around the ring body 20. Each of the storage portions 20 is adapted for a workpiece 2, such as a connector or handtool, removably connected for storage. The workpiece can be pipes installed on the fluid outlet or metal positioning elements. In addition, the storage portions can be also used to position the pipes. In the present embodiment, the ring body 10 is detachably disposed on a cover 4 the fluid pumping device 1. In other possible embodiments, as shown in FIG. 6, the ring body 10 can be a cover 30 disposed on a barrel 40 of the fluid pumping device. The cover 30 is detachably disposed on an opening 5 of the fluid pumping device 1. The ring body 10 can be used to cover a pumping mechanism 6 to allow the pumping device 6 to extend into the fluid pumping device 1.

More specifically, each of the storage portions 20 can be a clamping mechanism, an engaging mechanism, or other mechanisms for positioning each of the workpieces 2. In the present embodiment, each of the storage portions 20 has an insertion hole 21 for the workpiece 2 to removably insert through. More specifically, the insertion hole 21 can be a through hole for the workpiece 2 to insert through or a blind hole. Preferably, the insertion hole 21 is formed with a stepped face 22 radially. In the present embodiment, the stepped face 22 is an annular stepped face to support each of the workpieces 2. Besides, each of the storage portions 20 has a shoulder portion 23 around the insertion hole 21. The shoulder portion 23 extends radially. Preferably, the shoulder portions 23 is connected to the ring body 10 and expands toward the ring body 10 to enhance the engagement between each of the storage portions 20 and the ring body 10. In the present embodiment, each of the storage portions 20 is a seat protrudedly disposed on the ring body 10 around the ring body 10. The seat is formed with one of the insertion holes 21. Besides, the storage portions 20 are arranged spacedly in equal interval to reduce cost and to disperse the force. Preferably, the ring body 10 is further formed with a plurality of through holes 24. The through holes 24 and the insertion holes 21 are located at different positions along the radial direction of the ring body 10. Each of the through holes 24 can be used to receive the workpiece 2. Preferably, each of the insertion holes 21 has a different diameter from each of the through holes 24 to receive workpieces 2 in various sizes. In other possible embodiments, the insertion holes can have different diameters, and the through holes have different diameters too. In the present embodiment, the through holes 24 are arranged spacedly in equal interval to receive various workpieces 2 to prevent them from overlapping or collision.

More specifically, the ring body 10 is formed with a plurality of protrusions 25 on an inner wall thereof. The protrusions 25 can be engaged with recesses 7 of the fluid pumping device 1. In other possible embodiment, the protrusions can be formed on the fluid pumping device, and the recesses are formed on the inner wall of the ring body. In the present embodiment, the recesses 7 are formed on the cover 4 of the fluid pumping device 1. When the ring body 10 is sleeved onto the cover 4, the ring body 10 is unable to rotate due to the engagement between the protrusions 25 and the recesses 7. Besides, the ring body 10 has an expanded hole 26 in larger diameter and a reduced hole 27 in smaller diameter for being sleeved onto the fluid pumping device 1 for the installation of the cover and the pumping mechanism 6.

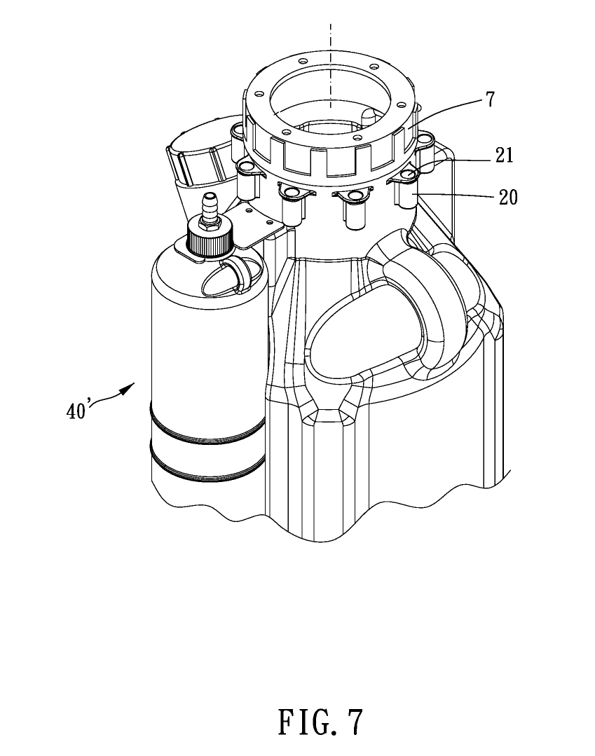

Besides, the storage structure for fluid pumping device further includes the barrel 40. The storage portions 20 are disposed on the outer face of the barrel 40 to surround the barrel 40. As shown in FIG. 7, the storage portions 20 are formed on the barrel 40′ integrally or detachably. In the present embodiment, the barrel 40 further includes a main body 41 and a collection container 42 detachably disposed on the barrel 40. The storage portions 20 are disposed on the outer face of the main body 41 to surround the main body 41. Thus, the collection container 42 can be easily detached for cleaning. The collection container 42 is positioned on the outer face of the barrel 40. In other possible embodiments, the collection container can be clamped on the barrel or formed on the barrel integrally.

In conclusion, the storage portions can be formed on the barrel or the cover integrally or disposed on the ring body to be detachable from the barrel or the cover. Thereby, workpieces can be received well to promote the efficiency. Besides, the storage portions can be used to position the pipes.

What is claimed is:

1. A storage structure for fluid pumping device, adapted for disposing on a fluid pumping device, the storage structure comprising:
a ring body, sleeved onto the fluid pumping device;
a plurality of storage portions, arranged around the ring body, each of the storage portions being adapted for a workpiece to removably connected.

2. The storage structure for fluid pumping device of claim 1, wherein the ring body is a cover to cover an opening of the fluid pumping device.

3. A storage structure for fluid pumping device, comprising:
a barrel;
a plurality of storage portions, arranged around the barrel to disposed on a periphery of the barrel, each of the storage portions being adapted for a workpiece to removably connected.

4. The storage structure for fluid pumping device of claim 1, wherein each of the storage portions has an insertion hole for the workpiece to removably insert through.

5. The storage structure for fluid pumping device of claim 4, wherein a stepped face is radially formed in each of the insertion holes.

6. The storage structure for fluid pumping device of claim 4, wherein each of the storage portion has a shoulder portion around the insertion hole, the shoulder portion extends along a radial direction of the insertion hole.

7. The storage structure for fluid pumping device of claim 1, wherein a plurality of protrusions on an inner annular wall of the ring body, the protrusions are adapted for engaging with a plurality of recesses on the fluid pumping device.

8. The storage structure for fluid pumping device of claim 1, wherein each of the storage portions has an insertion hole, a plurality of through holes are formed on the ring body, the through holes and the insertion holes are located at different positions along a radial direction.

9. The storage structure for fluid pumping device of claim 7, wherein each of the storage portions has an insertion hole for the workpiece to removably insert through; a stepped face is radially formed in each of the insertion holes; each of the storage portions is a seat protrudedly formed on a periphery of the ring body, the seat is formed with one of the insertion holes; each of the storage portion has a shoulder portion around the insertion hole, the shoulder portion extends along a radial direction of the insertion hole; the shoulder portion is connected to the ring body and expands toward the ring body; the ring body is formed with a plurality of through holes, the through holes and the insertion holes are located at different positions along the radial direction of the ring body; an inner diameter of each of the insertion holes is different from an inner diameter of each of the through holes; the storage portions are arranged spacedly; the through holes are arranged spacedly; the ring body is formed with an expanded hole for being sleeved onto the fluid pumping device and a reduced hole.

10. The storage structure for fluid pumping device of claim 3, wherein each of the receiving portions has an insertion hole, the insertion hole is adapted for the workpiece to removably inserted through; a stepped face is radially formed in each of the insertion holes; each of the storage portion has a shoulder portion around the insertion hole, the shoulder portion extends along a radial direction of the insertion hole; the barrel further includes a main body and a collection container detachably disposed on the main body, the storage portions are arranged around the main body outside the main body.
